(19) United States
(12) Patent Application Publication
(10) Pub. No.: US 2014/0234436 A1
(43) Pub. Date: Aug. 21, 2014

(54) SYSTEMS AND METHODS FOR CAPTURE, STORAGE, AND SUPPLYING PHOSPHINE GAS

(71) Applicants: James V. McManus, Bethel, CT (US); Edward A. Sturm, New Milford, CT (US); Thomas H. Baum, New Fairfield, CT (US); J. Donald Carruthers, Fairfield, CT (US); Joshua B. Sweeney, Katonah, NY (US)

(72) Inventors: James V. McManus, Bethel, CT (US); Edward A. Sturm, New Milford, CT (US); Thomas H. Baum, New Fairfield, CT (US); J. Donald Carruthers, Fairfield, CT (US); Joshua B. Sweeney, Katonah, NY (US)

(73) Assignee: ADVANCED TECHNOLOGY MATERIALS, INC., Danbury, CT (US)

(21) Appl. No.: 14/240,404

(22) PCT Filed: Jun. 12, 2012
(86) PCT No.: PCT/US12/41976

§ 371 Date: Feb. 23, 2014

Related U.S. Application Data
(60) Provisional application No. 61/526,283, filed on Aug. 23, 2011.

(51) Int. Cl. A01N 59/26; A01M 13/00

(52) U.S. Cl. CPC A01N 59/26; A01M 13/00
USPC 424/601; 222/1; 422/162

(57) ABSTRACT

A system and process for generating and packaging phosphine gas, in which the process includes: reacting water and aluminum phosphide to generate phosphine, and providing the phosphine in a gas mixture at a phosphine concentration below a lower explosive limit; adsorptively removing phosphine from the gas mixture; and packaging the removed phosphine in a fluid storage and dispensing vessel.

### FIELD

The present disclosure relates to systems and methods for supplying phosphine, e.g., for fumigation applications.

### DESCRIPTION OF THE RELATED ART

Phosphine gas is a useful fumigation agent for protecting grains and other natural products against infestation and attack by insects and rodents, and is employed in industrial fumigation activities in silos, cargo ships, and grain storage facilities worldwide.

The method that has been used for most fumigation during the past fifty years has involved the provision of aluminum phosphide as a fumigant source reagent, in tablet, pellet or powder form, that is reacted with water to form phosphine gas and aluminum oxide as hydrolysis reaction products. For such purpose, the aluminum phosphide may be placed in tablet form in air recirculation dispensers at the fumigation site, or pellets or powdered forms may be packaged in bags or sachets that are placed at such site, so that the aluminum phosphide reacts with atmospheric moisture to produce the phosphine gas fumigation agent.

Tablets are typically formulated with control agents to ensure that ignition of the phosphine does not take place, since phosphine is highly flammable, in addition to being highly toxic. Further, the aluminum oxide produced as a solid residue of the hydrolysis reaction must be removed from the air recirculation system, and care must be taken in handling to ensure that complete reaction has taken place, in deference to the pyrophoricity and toxicity of phosphine. The use of bags or sachets containing aluminum phosphide pellets or powder may also require the formulation or presence of control agents for suppressing ignition, and entail the further disadvantage that the bags and sachets holding the aluminum oxide residue must be removed from the fumigated material at the fumigation location after the hydrolysis reaction is complete.

The use of aluminum phosphide as a fumigant source reagent also entails the significant disadvantage of extreme variability in reaction rate. The time required for the aluminum phosphide fumigant source reagent to react and form phosphine gas depends on a number of factors, including moisture content of the material to be fumigated, ambient humidity at the fumigation location, and temperature at such location. In consequence of the uncertainty of these activating factors, controlling the concentration and the timing of the fumigant gas delivery is very difficult. The use of aluminum phosphide as a fumigant source reagent therefore entails significant reliability and reproducibility issues.

Efforts have also been made to utilize on-site generators in which aluminum phosphide is reacted with water to generate phosphine gas that then is fed to a recirculation system at the fumigation site. Such approach, however, entails a number of deficiencies, including materials handling of the aluminum phosphide material and hydrolysis reaction control/management at the fumigation site, as well as the added capital and operating costs of providing generators at the fumigation site.

Additional efforts have been made in recent years to provide extremely dilute phosphine gas mixtures in gas supply cylinders for fumigation use. Such gas mixtures typically contain phosphine at concentrations of 2% or less in air mixture, below the phosphine lower explosive limit. Such packaging enables the gas mixture to be directly utilized as a fumigant medium. This approach is not economical, since the large volume of gas required correspondingly necessitates transportation and handling of large numbers of air cylinders containing only low levels of phosphine.

Other approaches, such as the provision of liquefied phosphine in high-pressure vessels, present significant safety issues, since phosphine is highly flammable and very toxic.

Accordingly, there is a continuing need in the art for a safe, efficient and economical approach to supplying phosphine gas for fumigation applications.

### SUMMARY

The present disclosure relates to systems and methods for supplying phosphine, e.g., for fumigation applications.

The disclosure in one aspect relates to a method of generating and packaging phosphine, comprising: reacting water and aluminum phosphide to generate phosphine, and providing the phosphine in a gas mixture at a phosphine concentration below a lower explosive limit; adsorptively removing phosphine from the gas mixture; and packaging the removed phosphine in a fluid storage and dispensing vessel.

Another aspect of the disclosure relates to a phosphine generation and packaging apparatus, comprising: a phosphine generator adapted to react water and aluminum phosphide to generate phosphine; a diluent gas source arranged to supply diluent gas in such manner as to provide said phosphine in a gas mixture at a phosphine concentration below a lower explosive limit; adsorbent arranged to adsorptively remove phosphine from the gas mixture; and a packaging facility adapted to package the removed phosphine in a fluid storage and dispensing vessel.

The disclosure in a further aspect relates to a process for generating and packaging phosphine gas, such process comprising:

(a) generating phosphine gas;
(b) forming a gas mixture comprising the phosphine gas and inert gas;
(c) contacting the gas mixture with an adsorbent effective to sorptively remove phosphine gas therefrom, and yield phosphine-bearing adsorbent and phosphine-depleted gas mixture;
(d) separating the phosphine-bearing adsorbent from the phosphine-depleted gas mixture;
(e) optionally desorbing phosphine gas from the separated phosphine-bearing adsorbent; and
(f) packaging the separated phosphine-bearing adsorbent, or, if optionally desorbed, then the desorbed phosphine gas, in a fluid supply vessel.

In another aspect, the disclosure relates to a system for generation and packaging of phosphine gas, comprising:

(a) a phosphine gas generator;
(b) an inert gas source operatively arranged to supply inert gas to said phosphine gas generator for flow therethrough to form a gas mixture comprising phosphine gas and inert gas, or operatively arranged to supply inert gas to a mixing locus for combination with phosphine gas generated by said phosphine gas generator to form a gas mixture comprising phosphine gas and inert gas;
(c) an adsorber comprising adsorbent effective to sorptively remove phosphine gas from the gas mixture, said adsorber being arranged to receive said gas mixture from said phosphine gas generator or said mixing locus, to yield phosphine-bearing adsorbent and phosphine-depleted gas mixture; and
(d) a packaging facility adapted to receive phosphine-bearing adsorbent or phosphine desorbed from said phosphine-bearing adsorbent, for filling of a fluid supply vessel therewith.

Other aspects, features and embodiments of the disclosure will be more fully apparent from the ensuing disclosure and appended claims.

### BRIEF DESCRIPTION OF THE DRAWINGS

FIG. 1 is a schematic representation of a process system for production of phosphine and packaging of the phosphine in a fluid storage and dispensing vessel.

FIG. 2 is a schematic flow sheet of a method of generating phosphine and packaging same, followed by subsequent use of the vessel at the fumigation site for dispensing phosphine gas, and return of the vessel for reconditioning and refilling, according to another embodiment of the disclosure.

FIG. 3 is a schematic representation of a process system for production of phosphine and loading of a fluid storage and dispensing vessel, according to another embodiment of the disclosure.

FIG. 4 is a schematic representation of a phosphine supply apparatus, according to one embodiment of the disclosure.

FIG. 5 is a schematic representation of a phosphine supply apparatus, according to another embodiment of the disclosure.

### DETAILED DESCRIPTION

The present disclosure relates to systems and methods for supplying phosphine, e.g., for fumigation applications. In various aspects, the disclosure relates to integrated systems and methods for generating and packaging phosphine, and to associated supply arrangements in which packaged phosphine is produced and utilized in fumigation applications.

As used herein, the singular forms “a”, “and”, and “the” include plural referents unless the context clearly dictates otherwise.

The disclosure is set out herein in reference to various embodiments, and with reference to various features and aspects. The disclosure contemplates such features, aspects and embodiments in various permutations and combinations, as being within the scope of the disclosure. The compounds, apparatus, compositions and methods of the present disclosure may therefore be specified as comprising, consisting or consisting essentially of, any of such combinations and permutations of these specific features, aspects and embodiments, or a selected one or ones thereof.

In specific aspects, the disclosure relates to generation of phosphine in a safe and controlled manner utilizing sorptive capture and recovery of phosphine when produced as a reaction product in a gas mixture containing sufficient diluent to substantially reduce hazards otherwise associated with phosphine attributable to its pyrophoricity and toxicity, and packaging of the recovered phosphine gas in concentrated form in safe and effective fluid storage and dispensing vessels.

The initial generation of phosphine in a reaction mixture, in accordance with the disclosure, can be carried out in any suitable manner. In one approach, phosphine is generated from reaction of aluminum phosphide with water in which the product phosphine is in a dilute reaction mixture, or in which phosphine as it is generated is mixed with a diluent medium, such as an inert gas (e.g., nitrogen, argon, krypton, etc.).

The present disclosure in one embodiment contemplates the local generation of PH₃ by controlled hydrolysis of AIP powder (pellets) in a N₂ flow and the subsequent separation, purification and storage of PH₃ on a carbon adsorbent having high loading capacity, working capacity and selectivity for phosphine in multicomponent streams containing phosphine and diluent species. Various approaches for the separation, purification and storage of phosphine are described more fully herein, including the manufacture of packaged phosphine as useful for fumigation applications.

Such packaging of phosphine subsequent to generation, sorptive capture and recovery thereof, may employ fluid storage and dispensing apparatus of various types. Specific fluid storage and dispensing apparatus having particular utility for the packaging of phosphine in accordance with the disclosure include the fluid storage and dispensing vessels commercially available under the trademarks SDS® and VAC® from ATMI, Inc. (Danbury, Conn., USA).

Vessels of such type include adsorbent-based vessels, containing an adsorbent having sorptive affinity for phosphine, e.g., a solid-phase physical adsorbent material such as carbon, molecular sieve, or liquid ionic storage media, or other suitable storage materials which take up phosphine gas and release phosphine gas from the storage material under dispensing conditions. The adsorbent may advantageously be of a corresponding type to that utilized in the first instance to sorptively capture and recover phosphine upon its generation.

Vessels suitable for packaging of phosphine in accordance with the present disclosure also include vessels equipped with internal pressure regulators, in which one or more regulators is disposed in the interior volume of the vessel, and arranged so that pressure at the gas discharge port of the vessel determines whether the regulator(s) will enable dispensing flow to take place. Such pressure regulators may be of fixed or variable set point type, and may be continuously adjustable use, so that under storage conditions, when the vessel is filled with phosphine, the pressure regulator controlling dispensing is set at a set point pressure value that ensures no release of the phosphine to the ambient environment.

Vessels potentially useful in the broad practice of the present disclosure also include vessels containing adsorbent having sorptive affinity for phosphine, and also equipped with one or more internal pressure regulators. Vessels of such type are commercially available from Advanced Technology Materials, Inc. (Danbury, Conn., USA) under the trademark VACSORB.

Considering pressure-regulated vessels more specifically, in a particular embodiment, an internally pressure regulated vessel useful in the practice of the present disclosure may have a set point pressure regulator in the interior volume of the vessel, with a set point of 80 kPa (600 Torr), and with phosphine being contained in the interior volume of the vessel at a pressure of 13.8 megapascals (MPa) (2000 psig). In such vessel, the phosphine is stored at extremely high pressure, but in a fully safe manner since the pressure regulator will not allow dispensing flow unless pressure at the gas discharge port of the vessel is below the regulator set point value. In subsequent use, phosphine may be extracted from the internally pressure regulated vessel, by a vacuum pump, venturi, or other suitable extraction device, whereby a pressure below the set point value is applied at the gas discharge port of the vessel.

Such extraction devices may also be employed for dispensing of phosphine from adsorbent-based vessels in which phosphine is adsorbed by the sorbent medium and stored on such medium at low or even subatmospheric pressure.

In fumigation, the fumigant gas typically is required to be delivered to atmospheric pressure fumigation sites, such as grain storage silos and storage areas, residential, commercial and governmental buildings, packaged food warehouses, fruit and vegetable processing facilities, etc. In such atmospheric pressure fumigation sites, phosphine supplied in an adsorbed state in vessels containing adsorbent medium require active extraction devices and methods for fumigant gas delivery.

Considering again the initial generation of phosphine, e.g., as a hydrolysis product of phosphide reactants, the pyrophoric and toxic character of phosphine requires that it be diluted to levels consistent with safe handling and processing. Phosphine is desirably diluted to concentration on the order of about 2% by volume, based on total volume of the multicomponent mixture containing same, in order to prevent autoignition in exposure to air, and avoidance of lower explosive limit conditions.

The systems and methods of the present disclosure address the issues associated with the pyrophoric and toxic character of phosphine, and provide a safe, economical and efficient approach to generation and packaging of phosphine for fumigation applications.

The disclosure in various embodiments employs a “master-slave” arrangement of adsorbent vessels, in which the originally generated phosphine gas in a diluent medium is contacted with adsorbent in a master vessel, to physically adsorb phosphine on the adsorbent. Subsequent to such adsorption of the phosphine and the adsorbent in the master vessel, the phosphine is desorbed from such adsorbent in the master vessel, and flowed to “slave” vessel(s) containing adsorbent, whereby the phosphine is adsorbed on the adsorbent in the slave vessel(s), following which such slave vessel(s) are sealed to provide a package phosphine for subsequent use.

Such master-slave arrangement thereby achieves an initial separation of the phosphine from the diluent medium with which it is present in mixture, by adsorption on the adsorbent in the master vessel, followed by packaging in the slave vessel that is arranged in receiving relationship to the master vessel, to receive the phosphine desorbed from the adsorbent in the master vessel, and sorptively take up such transferred phosphine for final packaging of the gas. The packaged gas therefore is retained in an adsorbed state in the final package (slave vessel), and therefore is provided for subsequent use in a highly safe form, due to the sorptive affinity of the adsorbent.

As an alternative, the adsorbent utilized to initially adsorb the phosphine from the diluent gas can be separated from the diluent gas, with the separated phosphine-bearing adsorbent being transferred to a receiving vessel, in which the phosphine-bearing adsorbent is loaded to a predetermined extent, and the vessel then sealed. The resulting sealed vessel then can be transported and subsequently utilized in dispensing of phosphine gas from the adsorbent under dispensing conditions, e.g., for use as a fumigant medium.

In one embodiment, the disclosure relates to a method of generating and packaging phosphine, comprising: reacting water and aluminum phosphide to generate phosphine, and providing the phosphine in a gas mixture at a phosphine concentration below a lower explosive limit; adsorptively removing phosphine from the gas mixture; and packaging the removed phosphine in a fluid storage and dispensing vessel.

In such method, the phosphine can be adsorptively removed from the gas mixture by an adsorbent selected from among molecular sieves, carbon adsorbents, silica, alumina, macroreticulate resin adsorbents, and combinations of two or more of such adsorbents.

In a specific embodiment, the phosphine is adsorptively removed from the gas mixture by a carbon adsorbent. An illustrative carbon adsorbent may have at least one of the characteristics of: (i) a sorbent surface area in a range of from 980 to 1500 m²/gram, (ii) a bulk density of from 0.58 to 1.20 g/cc, and (iii) a fill capacity measured for phosphine gas at 650 Torr (86.7 kPa) pressure of 0.16 to 0.19 grams phosphine gas/gm adsorbent. Various embodiments may utilize adsorbent having the characteristic(s): (i); (ii); (iii); (i) and (ii); (i) and (iii); (ii) and (iii); or (i), (ii) and (iii). Thus, phosphine may be adsorptively removed from the gas mixture by a solid phase physical adsorbent. Such phosphine adsorptively removed from the gas mixture by the solid phase physical adsorbent can be desorbed from the adsorbent, and flowed to the fluid storage and dispensing vessel for packaging, e.g., at a flow rate of from 10 to 16 liters per minute, at pressure in a range of from 500 Torr (66.7 kPa) to 650 Torr (86.7 kPa).

The fluid storage and dispensing vessel can contain an adsorbent, which may be the same as or different from the adsorbent that is employed for initial recovery of the phosphine from the gas mixture comprising same. The adsorbent in the fluid storage and dispensing vessel can be selected from among molecular sieves, carbon adsorbents, silica, alumina, macroreticulate resin adsorbents, and combinations of two or more of such adsorbents. Such adsorbent in the fluid storage and dispensing vessel can be a carbon adsorbent. Such carbon adsorbent can have at least one of the characteristics of: (i) a sorbent surface area in a range of from 1000 to 1400 m²/gram, (ii) a bulk density of from 0.50 to 0.80 g/cc, and (iii) a fill capacity measured for phosphine gas at 650 Torr (86.7 kPa) pressure of 0.15 to 0.19 grams phosphine gas/gm adsorbent. Various embodiments may utilize adsorbent having the characteristic(s): (i); (ii); (iii); (i) and (ii); (i) and (iii); (ii) and (iii); or (i), (ii) and (iii).

The above-described method may further comprise dispensing phosphine from the fluid storage and dispensing vessel, e.g., at a flow rate of from 10 to 20 liters per minute, at pressure in a range of from 500 Torr (66.7 kPa) to 650 Torr (86.7 kPa). The phosphine dispensed from the fluid storage and dispensing vessel can be used for fumigation. The fluid storage and dispensing vessel can comprise an internally pressure regulated vessel. Such internally pressure regulated vessel can further contain a solid-phase physical adsorbent.

The disclosure in a further aspect relates to a phosphine generation and packaging apparatus, comprising: a phosphine generator adapted to react water and aluminum phosphide to generate phosphine; a diluent gas source arranged to supply diluent gas in such manner as to provide said phosphine in a gas mixture at a phosphine concentration below a lower explosive limit; adsorbent arranged to adsorptively remove phosphine from the gas mixture; and a packaging facility adapted to package the removed phosphine in a fluid storage and dispensing vessel.

The adsorbent in such apparatus may be selected from among molecular sieves, carbon adsorbents, silica, alumina, macroreticulate resin adsorbents, and combinations of two or more of such adsorbents. The adsorbent in a specific embodiment can comprise a carbon adsorbent. Such carbon adsorbent can have at least one of the characteristics of: (i) a sorbent surface area in a range of from 980 to 1500 m²/gram, (ii) a bulk density of from 0.58 to 1.20 g/cc, and (iii) a fill capacity measured for phosphine gas at 650 Torr p (86.7 kPa) pressure of 0.16 to 0.19 grams phosphine gas/gm adsorbent. Various embodiments may utilize adsorbent having the characteristic(s): (i); (ii); (iii); (i) and (ii); (i) and (iii); (ii) and (iii); or (i), (ii) and (iii).

The adsorbent advantageously comprises a solid phase physical adsorbent.

The apparatus may be constituted so that the adsorbent is adapted for desorption of adsorbed phosphine therefrom, and the apparatus further comprises flow circuitry arranged to flow phosphine desorbed from said adsorbent to the packaging facility.

The apparatus may be constituted, so that the fluid storage and dispensing vessel in the packaging facility contains an adsorbent. The adsorbent can be selected from among molecular sieves, carbon adsorbents, silica, alumina, macroreticulate resin adsorbents, and combinations of two or more of such adsorbents. In various embodiments, the adsorbent in the fluid storage and dispensing vessel is a carbon adsorbent. Such carbon adsorbent can have at least one of the characteristics of: (i) a sorbent surface area in a range of from 1000 to 1400 m²/gram, (ii) a bulk density of from 0.50 to 0.80 g/cc, and (iii) a fill capacity measured for phosphine gas at 650 Torr (86.7 kPa) pressure of 0.15 to 0.19 grams phosphine gas/gm adsorbent. Various embodiments may utilize adsorbent having the characteristic(s): (i); (ii); (iii); (i) and (ii); (i) and (iii); (ii) and (iii); or (i), (ii) and (iii).

The fluid storage and dispensing vessel in the packaging facility may comprise an internally pressure regulated vessel. Such internally pressure regulated vessel may contain a solid-phase physical adsorbent.

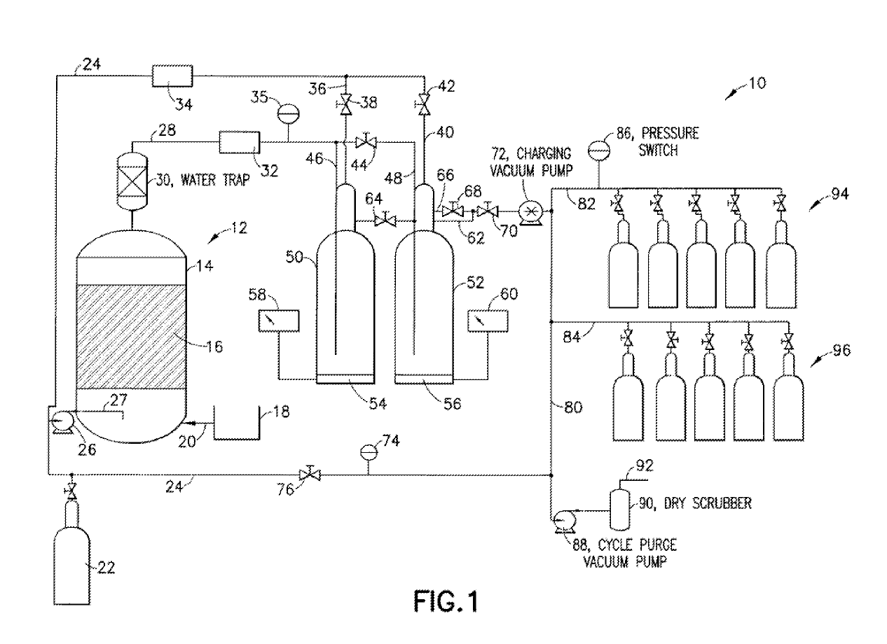

FIG. 1 is a schematic representation of a phosphine generation and packaging process system 10, according to a specific embodiment of the present disclosure.

As illustrated, the system 10 includes a phosphine generation reactor 12, comprising reactor vessel 14 containing a bed of aluminum phosphide 16 therein. The vessel is coupled in receiving relationship by line 20 with a water supply 18, by which reactant water or moisture is introduced into the interior volume of vessel 14 for reaction with the aluminum phosphide in bed 16. For such purpose, the water may be introduced to vessel 14 via nebulization, or by spray nozzle, or other appropriate device or inlet/introduction structure, whereby water is provided for the reaction with aluminum phosphide to form phosphine. Although the water reactant is shown in FIG. 1 as being introduced at the lower end of vessel 14, it will be appreciated that water vapor may be introduced from the upper end of the vessel, and that other arrangements may be employed to provide water in appropriate form and amount to carry out the phosphine generation reaction.

Vessel 14 is also arranged in receiving relationship to a nitrogen flow loop 24. The nitrogen flow loop 24 is supplied with nitrogen by nitrogen source vessel 22. The nitrogen source vessel may for example comprise a conventional high pressure gas cylinder containing high purity nitrogen. The nitrogen from nitrogen flow loop 24 is flowed under the action of pump 26 into nitrogen inlet line 27, for discharge into the interior volume of vessel 14.

With such arrangement, nitrogen gas introduced into the lower end of vessel 14 flows upwardly therein, together with introduced water or water vapor, to effect reaction of water and aluminum phosphide for the generation of phosphine. The resulting phosphine/nitrogen gas mixture then flows through discharge line 28 at the top of vessel 14, and through water trap 30.

The water trap 30 contains a suitable desiccant material, such as zeolite material having a 3 Angstrom pore size. The water trap 30 thereby effects drying of the phosphine/nitrogen gas mixture. The dried phosphine/nitrogen gas mixture then flows in discharge line 28, containing flow meter 32 and pressure switch 35, to the master absorbent vessels 50 and 52.

The master absorbent vessels 50 and 52 are reposed on scales 54 and 56 having read-outs 58 and 60, respectively. The discharge line 28 contains valve 44, by means of which flow to the respective vessels can be controlled. The vessels receive the phosphine/nitrogen gas mixture from discharge line 28 in branch feed lines 46 and 48, and the vessels during such charging with gas from discharge line 28 are arranged to flow phosphine-depleted nitrogen gas in branch lines 36 and 40 containing flow control valves 38 and 42, respectively, to the nitrogen flow loop 24.

By this arrangement, the phosphine/nitrogen gas mixture can be flowed from the discharge line 28 through the feed lines 46 and 48 into vessels 50 and 52. Each of the vessels 50 and 52 contains an adsorbent selective for phosphine, e.g., carbon adsorbent, so that phosphine in the phosphine/nitrogen gas mixture supplied by discharge line 28 flows through the carbon vessels 50 and 52. Phosphine in the phosphine/nitrogen gas mixture is adsorbed on the adsorbent in the vessels, and the resulting phosphine-depleted nitrogen gas is flowed in lines 36 and 40 (with valves 38 and 42 being open) to the nitrogen flow loop 24, containing flow meter 34 therein, for recirculating flow in the nitrogen flow loop.

In this manner, the respective master vessels 50 and 52 can be loaded with phosphine in an absorbed state on the adsorbent in the vessels. Once the vessels 50 and 52 are loaded with phosphine, the vessels are subjected to desorption operation, whereby phosphine is desorbed from the adsorbent in the vessels, and flowed to the slave vessels in the multi-vessel array 94 and/or 96 for filling of such slave vessels, following which such slave vessels may be sealed, removed from the fill manifold, and transported to storage or use facilities, as appropriate.

To effect filling of the slave vessels from the master vessels, valve 64 in discharge line 62 and valves 68 and 70 in discharge line 66, which were closed during the charging operation to fill vessels 50 and 52 with phosphine gas, are opened. Concurrently, the charging vacuum pump 72 in discharge line 66 is actuated to flow desorbed phosphine gas extracted from the master vessels into the manifold line 80 and then through branch lines 82 and/or 84 for filling of the slave vessels in arrays 94 and/or 96. For this purpose, the manifold fill line 82 associated with vessel array 94 is coupled with phosphine introduction lines connected to each vessel, wherein each of such phosphine introduction lines contains a flow control valve that may be opened to accommodate filling of the slave vessel with phosphine, or otherwise closed to isolate the slave vessel. The manifold fill line 84 associated with vessel array 96 is correspondingly constructed and operated. The manifold branch line 82 contains pressure switch 86, and manifold branch line 84 may similarly be equipped with a pressure switch or other pressure and/or flow monitoring device, to determine when the vessels in the array have been filled to an appropriate pressure or volumetric fill level.

Prior to filling of the slave vessels, such vessels and their associated flow circuitry can be evacuated by actuation of the cycle purge vacuum pump 88. The pumping action of cycle purge vacuum pump 88 exhausts the vessels in arrays 94 and 96 and their associated flow circuitry lines, and the resulting gas is flowed to dry scrubber 90 in which any contaminant species are removed. The correspondingly scrubbed gas is discharged from the system as vent gas in vent line 92. The vent gas then may be sent to further treatment, discharged to the atmosphere, or otherwise utilized or disposed of in any suitable manner.

The various pressure switches, flow meters and valves of the system may be integrated in a monitoring and control assembly, and the system may correspondingly include signal transmission capability whereby flow rates monitored by the flow meters or pressures monitored in the system in connection with pressure switches can be utilized as signals to a central processor unit adapted to receive monitoring signals and to output control signals that are utilized to control the sequence of process steps or operations in the process system 10.

The vessels in vessel arrays 94 and 96 may be of a type containing absorbent selective for phosphine gas, e.g., a carbon adsorbent, whereby phosphine gas transmitted from the master vessels 50 and 52 is introduced to a slave vessel in the respective slave vessel array and absorbed therein on the absorbent. In such arrangement, once the slave vessels in a slave vessel array are filled, the vessels can be sealed by closure of appropriate valves in the valve heads of such vessels, and the vessels removed from the manifold for subsequent disposition and use. The slave vessels in the slave vessel array can be filled simultaneously, or such vessels may be filled in serial fashion, whereby a first vessel in the array is filled to a desired pressure, weight or volume level, following which the vessel is closed, and phosphine gas is sent to the next vessel in the array, so that each of the vessels in the array is sequentially filled.

Thus, in one mode of operation of the system 10 shown in FIG. 1, the phosphine generation may be carried out to produce a phosphine/nitrogen gas mixture that is flowed in discharge line 28 to one or both of the master vessels 50 and 52, wherein phosphine is absorbed on the absorbent and a resulting phosphine-depleted gas mixture comprised mostly of nitrogen is discharged from the vessel(s), to the nitrogen flow loop 24. The vessels 50 and 52 may be charged with phosphine gas for absorption therein, either simultaneously or successively, as may be desired or useful in a given implementation of the process system.

Subsequently, with phosphine loaded in the master vessel(s), the “slave” vessels in the arrays 94 and 96 are arranged to receive phosphine dispensed under desorbing conditions from the master vessel(s), so that phosphine gas is transferred through the manifold fill lines 82 and 84 to the slave vessels. Prior to phosphine filling of the slave vessels, the slave vessels may be evacuated by a cycle purge vacuum pump, to remove any gas from such vessels, and thereby achieve high phosphine loading on the absorbent in the slave vessels.

As discussed above, the slave vessels in a given array may be filled simultaneously or successively, and the flow control valves in the respective lines may be coupled in controlled relationship to a process monitoring and control system, such as previously described involving a central processor unit, which may comprise a programmable logic controller, microprocessor, general purpose computer programmably arranged to carry out cyclic operation of the process system, etc., so that the process of generating phosphine, separating same from diluent gas, and filling of final package vessels is carried out automatically.

It will therefore be recognized that the process system shown in FIG. 1 can be arranged for continuous operation, with the phosphine/nitrogen gas mixture from the phosphine generation reactor being sent to one of the two master vessels, while the other vessel is off-stream or engaged in dispensing phosphine to one or more of the slave vessels in vessel arrays 94 and 96, with periodic switching of the vessels 50 and 52, so that one is on-stream receiving phosphine/nitrogen gas mixture from reactor 12, while the other is engaged in dispensing operation to fill one or more slave vessels.

Alternatively, the process system may be arranged so that the vessels 50 and 52 are filled with phosphine in a parallel, simultaneous manner, in a batch mode of operation, so that the vessels once filled are both placed in dispensing operation to fill slave vessels in the vessel arrays 94 and 96. During such dispensing operation, the flow of water to the phosphine generation reactor 12 from water source 18 would be terminated, and after the batch fill operation of the slave vessels is completed, phosphine generation action would begin again, by introduction of water from water source 18 to the vessel 14.

It will therefore be appreciated that the phosphine generation and packaging operation in a process system of the general type as shown in FIG. 1 can be carried out in a batch, semi-batch, or continuous fashion.

In a preferred configuration, the master and slave vessels both contain carbon adsorbent selective for phosphine. The adsorbent may be of a same or alternatively different type, as regards the pore size, pore size distribution, and other parameters of the respective adsorbents in the master and slave vessels.

In one embodiment, the adsorbent in the respective master and slave vessels are carbon adsorbents, having the properties set out in Table 1 (Master Vessel Adsorbent) and Table 2 (Slave Vessel Adsorbent) below, wherein PST is pore size distribution and “bet.” is “between.”

TABLE 1
Carbon Adsorbent Properties: Master Vessel (Phosphine-Inert-Gas Separation)

| Characteristic property | Measurement Method | Units | Low | High | Preferred |
|---|---|---|---|---|---|
| Surface Area | BET | m2/g | 980 | 1500 | 1015 |
| Bulk density | ASTM 4164 | g/cc | 0.58 | 1.20 | 1.10 |
| MicroPore Volume | t-plot | ml/g | 0.35 | 0.50 | 0.37 |
| MicroPore Volume | Dubinin-Astakhov | ml/g | 0.37 | 0.65 | 0.41 |
| Micropore size median | Dubinin-Stoeckli | nm | 0.52 | 1.30 | 0.56 |
| Micropore Size Distribution Width | Dubinin-Astakhov | exponent | 1.00 | 2.40 | 1.82 |
| Phosphine Fill Capacity | at 650 Torr | g/g | 0.16 | 0.19 | 0.19 |
| Macropore size median | PSD(Hg) | micron | 6.50 | 20.00 | 6.90 |
| Macropore Volume (>500 nm width) | PSD(Hg) | cc/g | 0.06 | 0.20 | 0.08 |
| Delivery Flow Rate | bet. 650-500 Torr | L/m | 1.00 | 16.00 | 2.00 |

500 Torr = 66.7 kPa; 650 Torr = 86.7 kPa

TABLE 2
Carbon Properties: Slave Cylinder (Sorbent-based Phosphine Storage)

| Characteristic property | Measurement Method | Units | Low | High | Preferred |
|---|---|---|---|---|---|
| Surface Area | BET | m2/g | 1000 | 1400 | 1335 |
| Bulk density | ASTM 4164 | g/cc | 0.50 | 0.80 | 0.58 |
| MicroPore Volume | t-plot | ml/g | 0.35 | 0.50 | 0.485 |
| MicroPore Volume | Dubinin-Astakhov | ml/g | 0.37 | 0.65 | 0.636 |
| Micropore size median | Dubinin-Stoeckli | nm | 0.52 | 1.30 | 1.2 |
| Micropore Size Distribution Width | Dubinin-Astakhov | exponent | 1.00 | 2.40 | 1.00 |
| Phosphine Fill Capacity | at 650 Torr | g/g | 0.15 | 0.19 | 0.169 |
| Macropore size median | PSD(Hg) | micron | 6.50 | 20.00 | 10 |
| Macropore Volume (>500nm width) | PSD(Hg) | cc/g | 0.20 | 0.30 | 0.25 |
| Delivery Flow Rate | bet. 650-500 Torr | L/m | 10.00 | 20.00 | 14 |

500 Torr = 66.7 kPa; 650 Torr = 86.7 kPa

The parametric ranges associated with the master and slave vessel adsorbents therefore include, in the case of the master vessel, a sorbent surface area in a range of from 980 to 1500 m²/gram, a bulk density of from 0.58 to 1.20 g/cc, a fill capacity measured for phosphine gas at 650 Torr (86.7 kPa) pressure of 0.16 to 0.19 grams phosphine gas/gm adsorbent, and a phosphine gas delivery flow rate, at pressure in a range of from 500 Torr (66.7 kPa) to 650 Torr (86.7 kPa), of from 10 to 16 L per minute; in the case of the slave vessel, the parametric ranges associated with the slave vessel adsorbent include a sorbent surface area in a range of from 1000 to 1400 m²/gram, a bulk density of from 0.50 to 0.80 g/cc, a fill capacity measured for phosphine gas at 650 Torr (86.7 kPa) pressure of 0.15 to 0.19 grams phosphine gas/gm adsorbent, and a phosphine gas delivery flow rate, at pressure in a range of from 500 Torr (66.7 kPa) to 650 Torr (86.7 kPa), of from 10 to 20 L per minute.

Thus, the disclosure contemplates various arrangements in which phosphine gas is generated by hydrolysis of aluminum phosphide, and such phosphine gas is sorptively removed from a diluent medium in which the reaction is carried out, with the sorptively removed phosphine thereafter being packaged.

The disclosure in one aspect relates to a process for generating and packaging phosphine gas, such process comprising:

(a) generating phosphine gas;
(b) forming a gas mixture comprising the phosphine gas and inert gas;
(c) contacting the gas mixture with an adsorbent effective to sorptively remove phosphine gas therefrom, and yield phosphine-bearing adsorbent and phosphine-depleted gas mixture;
(d) separating the phosphine-bearing adsorbent from the phosphine-depleted gas mixture;
(e) optionally desorbing phosphine gas from the separated phosphine-bearing adsorbent; and
(f) packaging the separated phosphine-bearing adsorbent, or, if optionally desorbed, then the desorbed phosphine gas, in a fluid supply vessel.

The foregoing process may be carried out in various specific implementations. In one such implementation, phosphine gas is desorbed from the separated phosphine-bearing adsorbent, as illustratively described hereinabove. In another implementation, desorption of phosphine gas from the separated phosphine-bearing adsorbent is not carried out.

The generation of phosphine gas in the first instance may be conducted in any suitable manner, and any appropriate synthesis reaction may be employed. In various specific embodiments, such generation of phosphine gas may be carried out by reacting aluminum phosphide and water. The water may be liquid water, or water vapor. The water may be present in a humidified inert gas that is contacted with aluminum phosphide to generate phosphine gas and yield the aforementioned gas mixture comprising phosphine gas and inert gas.

The phosphine generation and packaging process may be contacted with any suitable adsorbent for recovery of the phosphine from the phosphine/inert gas mixture. The adsorbent may for example comprise adsorbent selected from the group consisting of molecular sieves, carbon adsorbents, silica, alumina, and macroreticulate resin adsorbents, and combinations of two or more of such adsorbent species.

A preferred adsorbent for the recovery of the phosphine from the phosphine/inert gas mixture is carbon adsorbent.

The inert gas of the phosphine/inert gas mixture may likewise be of any suitable type, and may for example comprise a gas selected from the group consisting of nitrogen, argon, carbon dioxide, helium, krypton, neon, and mixtures of two or more of the foregoing.

In embodiments of the process broadly described above, wherein the fluid supply vessel is filled with the separated phosphine-bearing adsorbent in the packaging, the fluid supply vessel has an interior volume that may be filled to any appropriate level. For example, the interior volume is advantageously filled with the separated phosphine-bearing adsorbent in the packaging, to at least 50% of such interior volume, and in specific applications the fill of the interior volume with the separated phosphine-bearing adsorbent in the packaging may be at least 70% of such volume, at least 85% of such volume, at least 90% of such volume, at least 95% of such volume, or more.

As an alternative to the adsorbent-containing vessels discussed above, the fluid supply vessel employed in the packaging of the phosphine gas can be of a pressure-regulated type, including at least one pressure regulator disposed in the interior volume of the vessel. Multiple pressure regulator assemblies in the interior volume of the vessel may comprise two or more regulators, wherein each may have a different setting, e.g., set point, to provide highly safe and controlled retention of the phosphine gas in the vessel. Such pressure-regulated vessels may in specific embodiments have adsorbent selective for phosphine therein, or may be without adsorbent therein, as may be necessary or desirable in specific implementations of the disclosure.

The process may be carried out wherein the phosphine adsorbed from the gas mixture comprising phosphine and inert gas is subsequently desorbed, and the fluid supply vessel is filled with the desorbed phosphine gas. The fluid supply vessel in such case may contain an adsorbent for the phosphine gas, or the fluid supply vessel may be a pressure-regulated vessel with or without adsorbent disposed therein. Adsorbent used in such fluid supply vessels may be of any appropriate type, and may for example comprise an adsorbent selected from the group consisting of molecular sieves, carbon adsorbents, silica, alumina, and macroreticulate resin adsorbents. In various embodiments, the adsorbent in the fluid supply vessel may comprise carbon adsorbent.

The fluid supply vessel employed in the process for packaging of phosphine gas may be a reconditioned fluid supply vessel that has previously been filled with phosphine gas by the process of the disclosure, or other process, and which subsequent to the dispensing of phosphine gas from the vessel, i.e., so that the vessel has become depleted, is returned to the process user for reconditioning. The reconditioning may be of any suitable type, and may for example include bake-out (elevated temperature exposure), inert gas purge, solvent washing, vacuum evacuation, or other reconditioning processes.

Thus, the process of the disclosure contemplates, in a further aspect, reconditioning of an exhausted phosphine fluid supply vessel to yield a reconditioned fluid supply vessel for use in the packaging of phosphine according to the present disclosure.

The disclosure in another aspect relates to a system for generation and packaging of phosphine gas.

The system in various implementations comprises:

(a) a phosphine gas generator;
(b) an inert gas source operatively arranged to supply inert gas to said phosphine gas generator for flow therethrough to form a gas mixture comprising phosphine gas and inert gas, or operatively arranged to supply inert gas to a mixing locus for combination with phosphine gas generated by said phosphine gas generator to form a gas mixture comprising phosphine gas and inert gas;
(c) an adsorber comprising adsorbent effective to sorptively remove phosphine gas from the gas mixture, said adsorber being arranged to receive said gas mixture from said phosphine gas generator or said mixing locus, to yield phosphine-bearing adsorbent and phosphine-depleted gas mixture; and
(d) a packaging facility adapted to receive phosphine-bearing adsorbent or phosphine desorbed from said phosphine-bearing adsorbent, for filling of a fluid supply vessel therewith.

Such system may be implemented in various configurations. In one embodiment, the inert gas source is operatively arranged to supply inert gas to said phosphine gas generator for flow therethrough to form a gas mixture comprising phosphine gas and inert gas. In another embodiment, the inert gas source is operatively arranged to supply inert gas to a mixing locus for combination with phosphine gas generated by said phosphine gas generator to form a gas mixture comprising phosphine gas and inert gas.

The phosphine gas generator in such system may be of any appropriate type, and can for example be a generator that is adapted to react aluminum phosphide with water to form phosphine gas.

The system may further comprise a humidifier adapted to humidify the inert gas supplied by the inert gas source, wherein the inert gas source is operatively arranged to supply inert gas to the phosphine gas generator for flow therethrough to form a gas mixture comprising phosphine gas and inert gas.

The system may be constituted, so that the adsorber is arranged to desorb phosphine from the phosphine-bearing adsorbent and to discharge same to flow circuitry for flow to the packaging facility. The adsorber may comprise an adsorbent, e.g., in a fixed, fluidized, or other bed or presentation, that is selected from the group consisting of molecular sieves, carbon adsorbents, silica, alumina, and macroreticulate resin adsorbents.

In preferred practice, the adsorber comprises carbon adsorbent. The carbon adsorbent can for example be of a type that is characterized by at least one of the characteristics of: a sorbent surface area in a range of from 980 to 1500 m²/gram, a bulk density of from 0.58 to 1.20 g/cc, a fill capacity measured for phosphine gas at 650 Torr (86.7 kPa) pressure of 0.16 to 0.19 grams phosphine gas/gm adsorbent, and a phosphine gas delivery flow rate, at pressure in a range of from 500 Torr (66.7 kPa) to 650 Torr (86.7 kPa), of from 10 to 16 L per minute.

The inert gas source in the system can comprise a gas selected the group consisting of nitrogen, argon, carbon dioxide, helium, krypton, neon, and mixtures of two or more of the foregoing.

The system in one embodiment includes a packaging facility that comprises a glove box adapted to hold at least one fluid supply vessel for filling. The glove box may be adapted to be ventilated by flow of a ventilation gas therethrough, e.g., with inert gas from the inert gas source utilized to form the phosphine/inert gas mixture in the operation of the system.

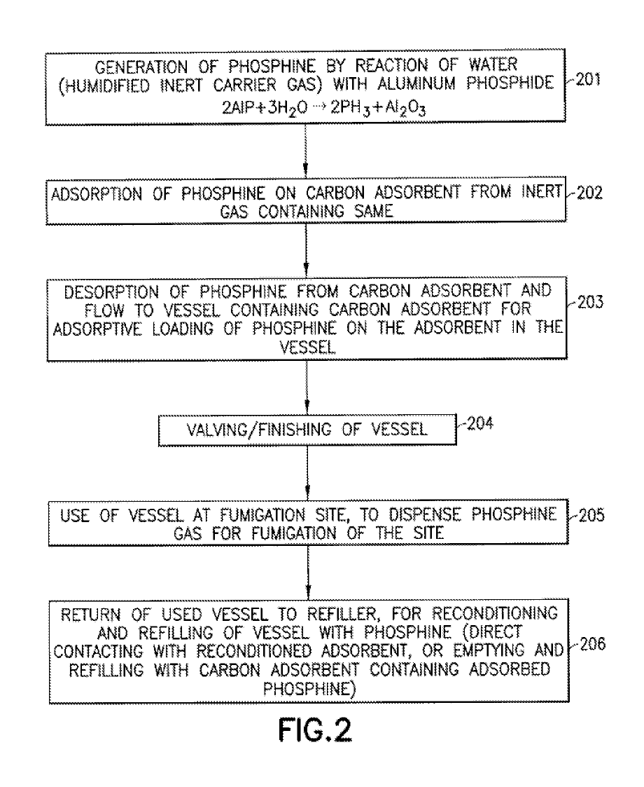

Referring again to the drawings, FIG. 2 is a schematic flow sheet of a method of generating phosphine and packaging same, followed by subsequent use of the vessel at the fumigation site for dispensing phosphine gas, and return of the vessel for reconditioning and refilling, according to one embodiment of the disclosure.

As illustrated, the method of FIG. 2 involves an initial step of generation of phosphine by reaction of water with aluminum phosphide (step 201), involving the reaction:

2AlP+3H₂O→2PH₃+Al₂O₃

in which the water may be supplied directly as liquid water, or alternatively by atmospheric moisture or a humidified inert carrier gas. For example, an inert carrier gas such as nitrogen, krypton, argon, helium, etc. can be employed, which is humidified to an appropriate extent for carrying out the reaction.

The reaction produces phosphine gas, and alumina (Al₂O₃) as a solid reaction byproduct. The contacting of aluminum phosphide and water is advantageously carried out with the humidified inert gas stream being flowed through a vessel containing the aluminum phosphide, so that the reaction product gas mixture discharge from the vessel contains phosphine in the inert gas component, at a concentration below the lower explosive limit, e.g., at a concentration of 2% phosphine by volume, based on total volume of the reaction product gas mixture containing phosphine and the inert diluent gas.

For such purpose, the specific contacting methodology may be widely varied, as regards the form and presentation of the aluminum phosphide material to the water reactant. For example, the aluminum phosphide may be provided in a particulate or otherwise finely divided form, in a fixed bed or a fluidized bed. The bed of aluminum phosphide particles is contacted with the moisture-containing inert gas stream, at an appropriate volumetric flow rate to avoid issues of deflagration and to yield a multicomponent gas mixture containing the phosphine reaction product gas and inert diluent gas at appropriate concentration.

If the reaction vessel containing the bed of aluminum phosphide particles is of a deflagration-resistant or explosion-proof character, phosphine gas may be generated at concentration levels above the aforementioned 2% by volume, based on volume of the gas mixture containing the generated phosphine, with subsequent dilution of the reaction product gas with the inert diluent gas to produce the multicomponent gas mixture containing phosphine at levels below the lower explosive limit. In general, however, it is desired to utilize contacting of the aluminum phosphide material with sufficient volumetric flow rate of the inert diluent gas to yield a phosphine-containing reaction chamber effluent in which phosphine is at a concentration not exceeding 2% by volume, based on volume of the gas mixture containing same.

In various specific embodiments, the concentration of phosphine in the reaction effluent gas mixture may be below 2% by volume, e.g., at concentration that is below 1.8%, 1.6%, 1.5%, 1.3%, 1.2%, 1%, 0.75%, 0.50%, or other maximum concentration selected to accommodate the toxicity and pyrophoricity of the phosphine reaction product.

Irrespective of the particular concentration of phosphine in the phosphine-containing gas mixture produced by the phosphine generation reaction, the phosphine will be in mixture with inert diluent. The inert diluent may be a single component inert gas species, or alternatively the inert diluent may comprise a multiplicity of inert diluent species.

The phosphine-containing inert gas mixture next is contacted with carbon adsorbent (step 202) to sorptively remove phosphine from the inert gas mixture, to yield a phosphine-depleted gas mixture. The carbon adsorbent may be of any suitable type that is effective in contact with the phosphine-containing inert gas mixture to adsorb phosphine. The carbon adsorbent may be provided in any suitable form or morphology, including, for example, powders, beads, rods, spheres, geometrically irregular particles, sheets, platelets, monolith forms (e.g., bricks, blocks, and the like, having a three-dimensional x, y, z structure in which each of the x, y, and z dimensions is at least 20 mm, preferably at least 25 mm, more preferably at least 40 mm and most preferably at least 50 mm), discs, cylindrical forms, honeycomb forms, or any other adsorbent article of appropriate size, shape and sorptive characteristics advantageous for removal of phosphine from the inert gas containing same.

In a particular aspect of the disclosure, the carbon adsorbent is provided for adsorptive removal of phosphine from the phosphine-containing inert gas mixture, having one or more of the following characteristics: a sorbent surface area in a range of from 980 to 1500 m²/gram, a bulk density of from 0.58 to 1.20 g/cc, a fill capacity measured for phosphine gas at 650 Torr (86.7 kPa) pressure of 0.16 to 0.19 grams phosphine gas/gm adsorbent, and a phosphine gas delivery flow rate, at pressure in a range of from 500 Torr (66.7 kPa) to 650 Torr (86.7 kPa), of from 10 to 16 L per minute.

As a result of the contacting of the phosphine-containing gas with the carbon adsorbent, phosphine is adsorbed on the carbon.

The FIG. 2 process flow therefore enables the bed of carbon that is initially employed for capture of phosphine subsequent to its generation to remain in place, e.g., in a fixed or fluidized bed. Such fixed or fluidized bed can be operated in a multiple bed arrangement, whereby one bed is in an active adsorption mode for recovery of phosphine from the synthesis gas mixture, while another of the multiple beds is undergoing regeneration or is on standby for subsequent renewal of active adsorption processing of the synthesis gas mixture, to recover phosphine therefrom. Such multiple bed arrangement may be carried out with processor control involving a CPU and/or a cycle time program unit, as adapted to cyclically switch respective ones of the multiple adsorbent beds, to achieve continuous operation in the phosphine generation and recovery system.

Next, the phosphine adsorbed on the carbon adsorbent from the phosphine-containing inert gas mixture is desorbed from such carbon adsorbent, and flowed to a vessel containing carbon adsorbent for sorptive loading of phosphine on the adsorbent in the vessel (step 203).

After the phosphine has been adsorbed on the carbon adsorbent in the storage and dispensing vessel, the vessel is processed by valving/finishing operations (step 203), to manufacture a phosphine storage and dispensing vessel in which phosphine is stored in an adsorbed state on the carbon adsorbent, and from which the phosphine may be desorbed under dispensing conditions, and discharged from the vessel for fumigation use.

The phosphine storage and dispensing vessel may for example comprise a gas cylinder-type container having an interior volume in which the phosphine-adsorbing carbon adsorbent is filled to a predetermined level, e.g., at least 50% of the interior volume, preferably at least 60% of the interior volume, more preferably at least 75% of the interior volume, and most preferably at least 85% of the interior volume of the container.

Once the phosphine is loaded on the carbon adsorbent in the interior volume of the vessel to a predetermined extent, the vessel may be completed by securing a valve head assembly to the vessel container. The valve head may be secured to the neck of the vessel container by threaded engagement of respective matable threaded surfaces, or the valve head may be welded, braised, or otherwise secured to the vessel body, so as to enclose the interior volume containing the phosphine-bearing carbon adsorbent. The valve head assembly may include the valve head and a suitable actuator, hand wheel, or other actuating or translating element or sub-assembly, by which the valve in the valve head is translatable between a fully opened and a fully closed state.

Subsequent to fabrication, the phosphine storage and dispensing vessel may be transported to a fumigation site, where the vessel is used to dispense phosphine gas for fumigation of the site (step 204). Since the adsorbed phosphine on the carbon adsorbent is contained in the vessel in a concentrated or neat form, phosphine may be dispensed at high purity and diluted with air or other gas at the fumigation site, to constitute the phosphine-containing fumigant medium that is employed for treatment of the fumigation site. It will be evident that the packaging of the phosphine at high purity on the carbon adsorbent avoids the need for shipment of large extremely dilute gas mixtures, and thereby the approach of the present disclosure, providing sorptively-bound phosphine, achieves a substantial advance in the art.

Because the phosphine is sorptively-bound on the carbon adsorbent, the phosphine may be stored at low pressure in the carbon sorbent-containing vessel. For example, the phosphine may be stored in adsorb form on the carbon adsorbent at subatmospheric pressure, whereby the risk associated with phosphine is ameliorated.

Dispensing of the phosphine gas from the sorbent-based phosphine storage and dispensing vessel can be carried out at the fumigation site in any suitable manner. For example, the phosphine gas may be stored at subatmospheric pressure in the vessel, and extracted therefrom by use of a vacuum pump, venturi, cryopump, ejector, fan, blower, or other motive extraction device by which phosphine is dispensed from the vessel containing same. Alternatively, the phosphine may be extracted by flowing of a carrier gas through the interior volume of the vessel containing the carbon adsorbent having phosphine adsorbed thereon, whereby a resulting concentration gradient results in desorption of the phosphine and entrainment of the desorbed phosphine in the carrier gas stream.

Subsequent to exhaustion of the phosphine-containing vessel, the vessel containing spent sorbent (depleted in phosphine sorbate) may be returned to a reseller, for reconditioning and refilling of the vessel with phosphine (step 205). This vessel renewal operation may involve reconditioning the adsorbent for renewed adsorption loading with phosphine, such as by bake out and inert purging of the adsorbent mass. Such renewal operation may be conducted in situ with the adsorbent being retained in the vessel during the reconditioning thereof, followed by filling with phosphine by adsorption of phosphine from an inert gas mixture containing same, as previously described.

Alternatively, the spent adsorbent may be removed from the vessel containing same, with the vessel thereafter being reconditioned, e.g., by purging, acid washing, etc., followed by introduction of fresh carbon adsorbent into the interior volume of the vessel. The fresh carbon adsorbent may be processed as previously described, so that it contains adsorbed phosphine resulting from the sorptive capture of phosphine from reaction product gases containing same, as previously described, or the fresh carbon adsorbent may subsequent to its introduction of the vessel be contacted with such phosphine-containing gas.

It will therefore be appreciated that phosphine generation and packaging, as well as subsequent use and used vessel reconditioning operations, can be carried out in a simple and efficient manner, to provide a method of phosphine supply for fumigation applications, that affords a high degree of safety in respect of the toxicity and pyrophoric character of the phosphine gas. Further, the phosphine gas is packaged in a gas storage vessel at high purity, thereby avoiding the substantial capital and operating costs associated with shipment of extremely dilute phosphine gas mixtures for fumigation usage.

As alternative to the foregoing process of generation and packaging of phosphine, phosphine can be generated as above described, with the phosphine/diluent gas mixture being contacted with an adsorbent to sorptively remove phosphine from the gas mixture. In this alternative process, the adsorbent bearing the adsorbed phosphine may then itself be packaged for storage and subsequent use of the phosphine. For example, the contacting of the phosphine/diluent gas mixture with the adsorbent may be carried out in a contacting vessel that after subsequent loading with phosphine is closed, valved and finished, to provide a phosphine supply vessel. Alternatively, the phosphine-bearing adsorbent may be transferred to a final phosphine storage and dispensing vessel, in a master vessel/slave vessel arrangement.

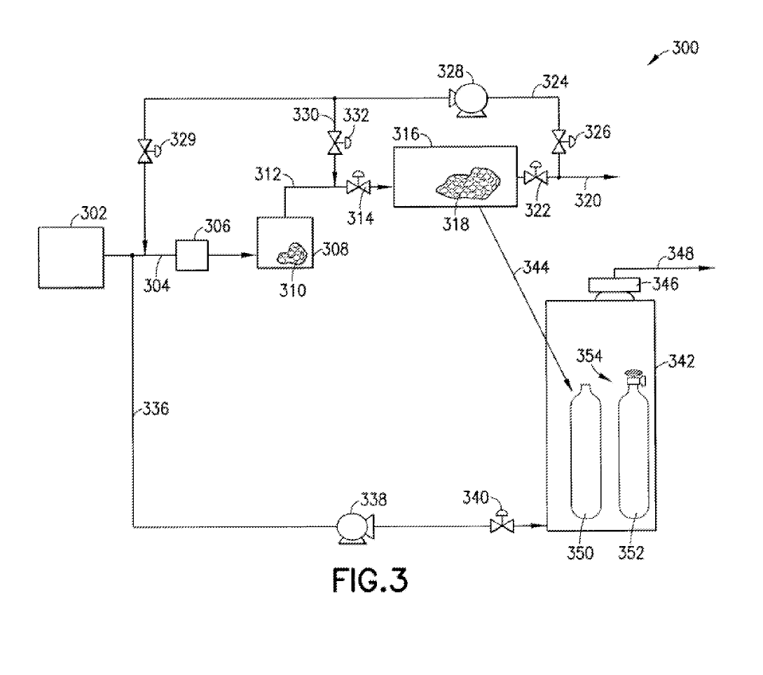

FIG. 3 is a schematic representation of a process system 300 for production of phosphine and loading of fluid storage and dispensing vessels, according to another embodiment of the disclosure.

In such process system, a source 302 of inert gas is arranged to flow such gas through the inert gas feed line 304 containing humidifier 306 to the reaction chamber 308 containing aluminum phosphide 310 in a particulate or other discontinuous form. The inert gas from source 302 may be of any suitable type, such as nitrogen, argon, krypton, helium, etc., and is humidified by the humidifier 3062 an appropriate humidity level for the subsequent reaction in reaction chamber 308.

The water in the humidified inert gas stream reacts with the aluminum phosphide 310 in reaction chamber 308 to generate phosphine gas. The resulting gas mixture including the inert gas and phosphine then flows from the reaction chamber 308 in discharge line 312 containing flow control valve 314 therein, to the adsorbent contacting chamber 316, containing carbon adsorbent 318. As a result of the contact of the phosphine gas-containing gas stream introduced from discharge line 312 with the carbon adsorbent 318 in the adsorbent contacting chamber 316, phosphine from the gas stream is adsorbed on the carbon adsorbent, to yield phosphine-bearing carbon adsorbent.

This phosphine-bearing carbon adsorbent then is transferred from adsorbent contacting chamber 316 via the gravitational feed line 344 to the gas supply vessel 350 in glove box 342 for filling of the vessel with the phosphine-bearing carbon adsorbent. The resulting vessel then is completed by installation of a valve head assembly 354 as shown on completed vessel 352 in the glove box. The completed vessel then is removed from the glove box 342 and placed in service.

The glove box 342 may be ventilated with inert gas to accommodate the handling of the phosphine-bearing carbon adsorbent. For such purpose, it may be advantageous to flow inert gas deriving from source 302 in line 336 containing pump 338 and flow control valve 340, to the glove box 342, with the ventilation gas being exhausted through the roof unit 346 on the glove box in exhaust line 348.

The gas mixture flowing through the adsorbent contacting chamber 316 and correspondingly depleted in phosphine content as a result of such contacting, is discharged from such chamber in discharge line 320 containing flow control valve 322 therein. The discharged gas in line 320 may be at least partially recycled in recycle line 324 containing flow control valve 326, pump 328 and flow control valve 329, whereby the recycle gas is flowed to inert gas feed line 304 for recirculation through the humidifier 306, reaction chamber 308 and adsorbent contacting chamber 316. The recycle line 324 is also joined in flow communication with branch line 330 containing flow control valve 332 therein, whereby gas from the recycle line 324 can be recirculated through branch line 330 and discharge line 312 to the adsorbent contacting chamber 316. By appropriate opening/closing of valves 329, 332 and 326, the gas recirculation can be modulated and directed as desired.

In lieu of the gravitational feed line 344, phosphine-bearing carbon adsorbent can be transferred to the glove box 342 via mechanical conveyor belt, pneumatic transfer conduit, or other transfer mechanism, whereby the phosphine-bearing carbon adsorbent is delivered to the packaging operation, for introduction to the interior volume of a vessel, for fabrication of a phosphine storage and dispensing supply apparatus.

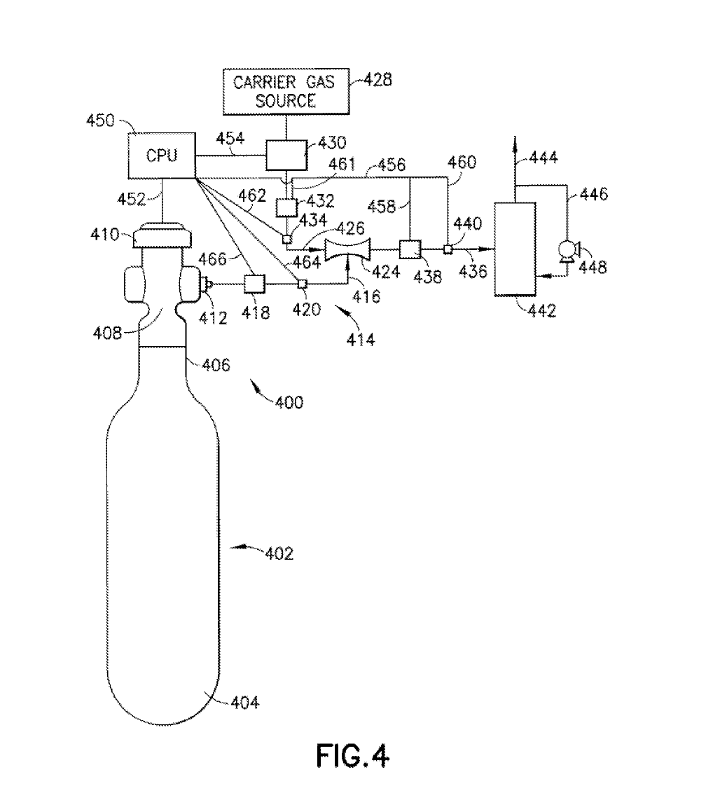

FIG. 4 is a schematic representation of a system 400 for supplying phosphine gas for fumigant applications. The system 400 includes a fluid storage and dispensing package 402, which can include a sorbent-containing vessel having phosphine gas sorptively retained on a physical sorbent therein, and/or an internal regulator-equipped vessel containing phosphine at pressure that is confined by an internal regulator having a fixed or adjustable set point that is accommodated to the dispensing operation. For example, the regulator in the fluid storage and dispensing package may be set to a sub-atmospheric pressure, so that phosphine gas is not dispensed from the vessel unless the regulator is exposed to an external pressure that is equal to or below the sub-atmospheric set point pressure.

The fluid storage and dispensing package 402 includes a cylindrical vessel 404 of vertical upstanding orientation, holding the fluid therein for dispensing, and coupled at its neck portion with a valve head dispensing assembly 408 containing a valve therein that is actuated by the manual hand wheel 410, or otherwise by an automatic valve actuator coupled to the valve in the valve head. The valve head dispensing assembly 408 has a fluid dispensing port 412 that is joined to a fluid dispensing line 416 containing therein a dispensed fluid flow controller 418, which can for example include a mass flow controller, restricted flow orifice, flow control valve, or other flow control devices, as well as a dispensed fluid monitor 420, which can include a sensor, detector, gas analyzer assembly or other device or apparatus for monitoring the dispensed fluid.

The fluid dispensing line 416 is coupled with the throat of a venturi 424, for extracting the phosphine from the fluid storage and dispensing package 402 for entrainment and mixing with the carrier gas from carrier gas source 428. By way of specific example, the venturi may be arranged to provide a phosphine-containing air mixture, in which the concentration of phosphine is in a range of from about 800 to about 1200 ppm.

The carrier gas source 428 can be of any suitable type. For example, the carrier gas can be ambient air or air that is filtered or purified for flow to the venturi, or the carrier gas may be provided in a source vessel or other supply apparatus. The carrier gas from carrier gas source 428 is flowed in carrier gas feed line 426 to the venturi 416, and the resulting gas mixture of carrier gas and fluid from the fluid storage and dispensing package 402 is flowed out of the venturi in discharge line 436 to the end use location 442, which can be any appropriate locus or facility in which the gas mixture stream from the venturi is usefully applied, e.g., for fumigation of foodstuffs in a food storage installation such as a warehousing facility, grain silo, brewery, food processing plant, etc.

The introduced gas at such location 442 can be discharged from the location in discharge line 444, and/or recycled in recirculation loop 446 containing pump 448 or other suitable motive fluid driver therein, to ensure appropriate gas change rate or throughput of gas at the location 442.

The carrier gas feed line 426 may have any suitable process components therein, or coupled thereto, such as a motive fluid driver 430, a flow controller 432, a carrier gas monitor 434, and/or any other elements or sub-systems that assist in the feed of the carrier gas medium to the venturi. The motive fluid driver 430 can include a pump, compressor, blower, fan, or other driver. The flow controller can include a restricted flow orifice, flow control valve, or other control device or assembly. The monitor 434 can be of any suitable type, e.g., a flow rate sensor, a gas analyzer, a pressure transducer, etc.

In like manner, the discharge line 436 from the venturi can contain or be coupled to any similar motive fluid driver, flow control and monitoring components, e.g., a motive fluid driver and flow control assembly 438 and a monitoring element 440.

The gas supply system 400 of FIG. 4 can include an automatic control system, e.g., a central processing unit (CPU) 450 as shown, which is linked in signal transmission relationship to various system components by respective signal transmission lines, including line 452 to valve actuator 410 (which in such case would be an automatically controllable actuator), line 154 to motive fluid driver 430, line 461 to flow controller 432, line 462 to carrier gas monitor 434, line 466 to dispensed fluid flow controller 418, line 464 to dispensed fluid monitor 420, line 458 to motive fluid driver and flow control assembly 438 and line 460 to monitoring element 440, with lines 458, 460 and 461 being joined in turn to the signal transmission line 456.

The signal transmission lines may be used to transmit monitoring signals indicative of monitored process conditions or parameters to the CPU 450 from appropriate components, and for transmitting control signals to controlled components of the system. The CPU 450 can be of any appropriate type, e.g., a microprocessor, microcontroller, programmable logic unit, programmable general purpose computer, or other appropriate apparatus including hardware/software suitable for the monitoring and control of the system. The CPU 450 may be programmably arranged to actuate the system for dispensing of gas from package 402 at predetermined intervals, according to a cycle timer program, or at times that are determined by monitoring or conditions obtaining in the location 442.

In applications in which an sorbent-containing vessel or a regulator-equipped vessel are employed in accordance with the invention, in combination with a motive fluid driver and associated flow circuitry, the motive fluid driver and associated flow circuitry may be fabricated in an integral manner with respect to the vessel, to provide a unitary package for gas storage and dispensing. Alternatively, the vessel, motive fluid driver and associated flow circuitry may be provided as components of a kit, for assembly by a user at the point of use. The vessel in such kit may be provided in an empty state, for subsequent charging with fluid, or alternatively, the vessel may be pre-loaded with fluid for fluid dispensing upon the assembly of the kit components.

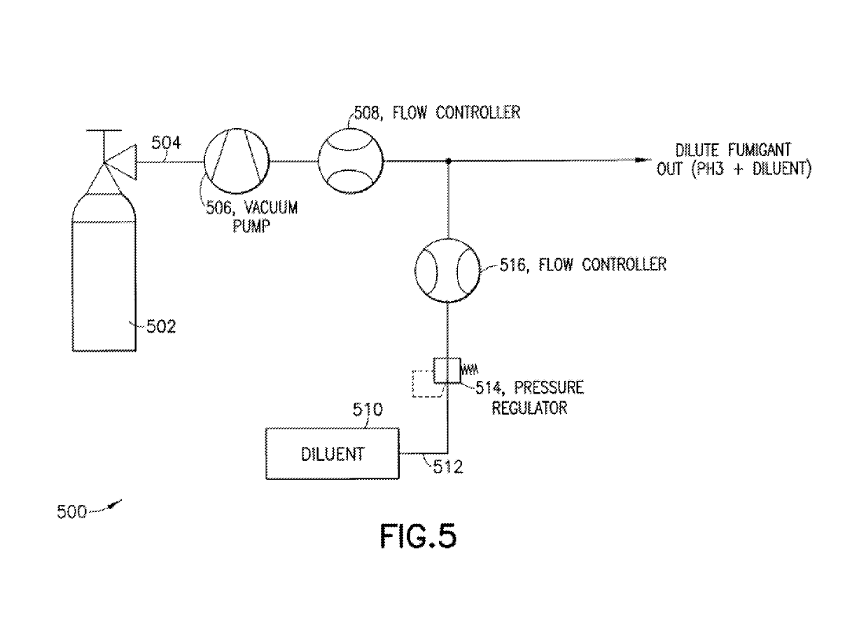

FIG. 5 is a schematic representation of a phosphine supply apparatus 500, according to another embodiment of the disclosure.

As illustrated, the phosphine supply apparatus 500 includes a phosphine storage and dispensing vessel 502 arranged to dispense phosphine gas to feed line 504 containing vacuum pump 506 and flow controller 508 therein. A diluent source 510 is arranged to supply diluent gas to diluent gas feed line 512 containing pressure regulator 514 and flow controller 516 therein.

By this arrangement, phosphine gas from the vessel 502 is extracted by vacuum pump 506 and flows at a rate determined by flow controller 508, for mixing with diluent gas from diluent source 510 flowed in line 512 at a pressure and flow rate determined by pressure regulator 514 and flow controller 516, so that the phosphine gas and diluent gas are mixed in the feed line 504 to form a fumigant gas mixture comprising the phosphine gas and diluent gas.

The flow controllers 508 and 516 may be of any suitable type, and may for example comprise adjustable valves, such as butterfly or needle valves, restricted flow orifice devices, rotameters, mass flow controllers, or any other devices that are effective to controllably modulate the flow of gases in the respective lines in which they are deployed.

The fumigant system may additionally include a processor, such as a programmable logic device, microprocessor, programmable computer, central processor unit (CPU), or other programmed or programmable device, which is usefully employed in monitoring and control of the fumigation operation. For example, the processor may be operationally linked to a venturi device, to monitor influent gas streams and the effluent gas phosphine concentration, and to responsively modulate flow rates of the phosphine gas and/or diluent gas, to achieve a set point or otherwise desired phosphine concentration in the fumigant gas mixture.

The vessel 502 may be of a sorbent-based type as previously described, containing an adsorbent selective for phosphine, from which phosphine previously adsorbed on the adsorbent can be desorbed under dispensing conditions involving operation of the vacuum pump for extraction of the phosphine gas.

Alternatively, the vessel 502 may be of an internally disposed regulator type, as a pressure regulated vessel from which phosphine can be extracted during operation of the vacuum pump 506 to effect phosphine gas dispensing.

In arrangements of the present disclosure, in which the vessel is a sorbent-based vessel or an internally disposed regulator vessel (i.e., pressure regulated vessel), the phosphine gas can be extracted and diluted in a single step operation. A venturi can be installed outside the phosphine supply vessel and using a desired diluent gas, the phosphine can be extracted and diluted with a single device. The venturi can be sized and/or the extracted phosphine gas and drive gas inlets can be throttled, using throttle valves or flow control devices, to control the concentration of phosphine in the phosphine/diluent gas mixture so that it is at or below a predetermined concentration level. Such venturi technique provides a simple operational approach to on-site fumigant gas preparation, since the hardware, set up, and operation of the fumigation system are of a simple and low cost character.

The phosphine generation and packaging approach of the present disclosure can also be applied to very large-scale adsorbent containers in which phosphine subsequent to its generation and sorptive recovery is packaged in an adsorbent-containing vessel of substantial size, e.g., tube trailer vessels that are mounted on trailer assemblies for vehicular transport by a truck or lorry drive vehicle. Such large-scale vessels are able to sorptively hold tonnage quantities of phosphine, such as might be used for fumigation, e.g., over an extended time period such as 24-48 hours, of correspondingly large-sized fumigation sites, such as cargo holds of ships, large-sized warehouse facilities, residential apartment buildings, commercial buildings, and the like.

The provision of large size containers of sorptively held phosphine thus affords the ability for extended duration fumigation, as well as ability to accommodate a long service life with fumigation applications of significantly smaller temporal extent, as serviced from a large size container. The mounting of large scale containers of sorptively held phosphine on or in motive vehicular apparatus, e.g., highway vehicles, ships, airplanes, etc. also affords the ability to achieve ready transport of the containers to fumigation locations at various distances from a local phosphine generation facility.

Vessels used for sorptive storage of phosphine for fumigation applications thus can be of widely varying size, e.g., from 1-2 liters in interior volume capacity for small scale applications to 20 to 75 liters for intermediate interior volume capacity, e.g., 49 liter capacity, to tonnage scale large vessels.

While the disclosure has been has been described herein in reference to specific aspects, features and illustrative embodiments of the disclosure, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the invention as hereinafter claimed is intended to be broadly construed and interpreted, as including all such variations, modifications and alternative embodiments, within its spirit and scope.

1. A method of generating and packaging phosphine, comprising:
reacting water and aluminum phosphide to generate phosphine, and providing the phosphine in a gas mixture at a phosphine concentration below a lower explosive limit; adsorptively removing phosphine from the gas mixture; and packaging the removed phosphine in a fluid storage and dispensing vessel.

2. The method of claim 1, wherein phosphine is adsorptively removed from the gas mixture by an adsorbent selected from among molecular sieves, carbon adsorbents, silica, alumina, macroreticulate resin adsorbents, and combinations of two or more of such adsorbents.

3. The method of claim 1, wherein phosphine is adsorptively removed from the gas mixture by a carbon adsorbent, wherein the carbon adsorbent has at least one of the characteristics of: (i) a sorbent surface area in a range of from 980 to 1500 m²/gram, (ii) a bulk density of from 0.50 to 1.20 g/cc, and (iii) a fill capacity measured for phosphine gas at 650 Torr pressure (86.7 kPa) of 0.15 to 0.19 grams phosphine gas/gm adsorbent.

4.-11. (canceled)

12. The method of claim 1, wherein the phosphine is adsorptively removed from the gas mixture by a solid phase physical adsorbent, and wherein (i) phosphine adsorptively removed from the gas mixture by the solid phase physical adsorbent is desorbed from said adsorbent, and flowed to said fluid storage and dispensing vessel for said packaging, or (ii) said solid phase physical adsorbent, having phosphine adsorptively removed from the gas mixture adsorbed thereon, is passed to said fluid storage and dispensing vessel for said packaging.

13. (canceled)

14. The method of claim 13, wherein said phosphine desorbed from said adsorbent is flowed to said fluid storage and dispensing vessel for said packaging, at a flow rate of from 5 to 20 liters per minute, at pressure in a range of from 500 Torr (66.7 kPa) to 650 Torr (86.7 kPa).

15. The method of claim 1, wherein said fluid storage and dispensing vessel contains an adsorbent.

16. The method of claim 15, wherein said adsorbent in said fluid storage and dispensing vessel is selected from among molecular sieves, carbon adsorbents, silica, alumina, macroreticulate resin adsorbents, and combinations of two or more of such adsorbents.

17. The method of claim 15, wherein said adsorbent in said fluid storage and dispensing vessel comprises a carbon adsorbent, wherein the carbon adsorbent has at least one of the characteristics of: (i) a sorbent surface area in a range of from 980 to 1500 m²/gram, (ii) a bulk density of from 0.50 to 1.20 g/cc, and (iii) a fill capacity measured for phosphine gas at 650 Torr pressure (86.7 kPa) of 0.15 to 0.19 grams phosphine gas/gm adsorbent.

18.-25. (canceled)

26. The method of claim 1, further comprising dispensing phosphine from said fluid storage and dispensing vessel.

27. The method of claim 26, wherein said fluid storage and dispensing vessel is adapted to dispense phosphine at a flow rate of from 5 to 20 liters per minute, at pressure in a range of from 500 Torr (66.7 kPa) to 650 Torr (86.7 kPa).

28. The method of claim 26, wherein phosphine dispensed from said fluid storage and dispensing vessel is used for fumigation.

29. The method of claim 1, wherein the fluid storage and dispensing vessel comprises an internally pressure regulated vessel.

30. (canceled)

31. A phosphine generation and packaging apparatus, comprising:
a phosphine generator adapted to react water and aluminum phosphide to generate phosphine;
a diluent gas source arranged to supply diluent gas in such manner as to provide said phosphine in a gas mixture at a phosphine concentration below a lower explosive limit;
adsorbent arranged to adsorptively remove phosphine from the gas mixture; and
a packaging facility adapted to package the removed phosphine or adsorbent having phosphine adsorptively removed from the gas mixture adsorbed thereon in a fluid storage and dispensing vessel.

32. The apparatus of claim 31, wherein said adsorbent is selected from among molecular sieves, carbon adsorbents, silica, alumina, macroreticulate resin adsorbents, and combinations of two or more of such adsorbents.

33. The apparatus of claim 31, wherein said adsorbent comprises a carbon adsorbent, wherein the carbon adsorbent has at least one of the characteristics of: (i) a sorbent surface area in a range of from 980 to 1500 m²/gram, (ii) a bulk density of from 0.50 to 1.20 g/cc, and (iii) a fill capacity measured for phosphine gas at 650 Torr (86.7 kPa) pressure of 0.15 to 0.19 grams phosphine gas/gm adsorbent.

34.-41. (canceled)

42. The apparatus of claim 31, wherein the adsorbent comprises a solid phase physical adsorbent.

43. (canceled)

44. The apparatus of claim 31, wherein said fluid storage and dispensing vessel in said packaging facility contains an adsorbent.

45. The apparatus of claim 44, wherein said adsorbent in said fluid storage and dispensing vessel is selected from among molecular sieves, carbon adsorbents, silica, alumina, macroreticulate resin adsorbents, and combinations of two or more of such adsorbents.

46. The apparatus of claim 44, wherein said adsorbent in said fluid storage and dispensing vessel comprises a carbon adsorbent, wherein the carbon adsorbent has at least one of the characteristics of: (i) a sorbent surface area in a range of from 980 to 1500 m²/gram, (ii) a bulk density of from 0.50 to 1.20 g/cc, and (iii) a fill capacity measured for phosphine gas at 650 Torr (86.7 kPa) pressure of 0.15 to 0.19 grams phosphine gas/gm adsorbent.

47.-54. (canceled)

55. The apparatus of claim 31, wherein the fluid storage and dispensing vessel in said packaging facility comprises an internally pressure regulated vessel.

56.-91. (canceled)
